(19) United States
(12) Patent Application Publication
(10) Pub. No.: US 2016/0170096 A1
(43) Pub. Date: Jun. 16, 2016

(54) LENS MEMBER MANUFACTURING METHOD, LENS MEMBER, CURVED SURFACE SHAPE PATTERN MANUFACTURING METHOD, AND RESIN FILM FOR FORMING CURVED SURFACE SHAPE PATTERN

(71) Applicant: HITACHI CHEMICAL COMPANY, LTD., Tokyo (JP)

(72) Inventors: Daichi SAKAI, Tsukuba-shi, Ibaraki (JP); Toshihiro KURODA, Oyama-shi, Tochigi (JP)

(21) Appl. No.: 14/908,631

(22) PCT Filed: Aug. 5, 2014
(86) PCT No.: PCT/JP2014/070648

§ 371 Date: Jan. 29, 2016

(30) Foreign Application Priority Data
Aug. 9, 2013 (JP) 2013-165931

(51) Int. Cl. G02B 3/00; B32B 27/36; B29D 11/00; B32B 27/30

(52) U.S. Cl. CPC G02B 3/0012; B32B 27/308; B32B 27/36; B29D 11/00009; B29D 11/00442; B32B 2250/02; B32B 2367/00; B32B 2333/12; B32B 2379/08; B32B 2551/00

(57) ABSTRACT

To provide a method for producing a lens member with which an intended lens shape can be formed on an arbitral substrate, and a lens member and a curved surface shape pattern which are produced by the said method. Also to provide a resin film for forming a curved surface shape pattern with which a lens can be formed. [Solution] A method for producing a lens comprises: Step A in which a laminate body comprising a substrate, a resin layer for forming a curved surface shape disposed on the substrate, and a resin layer for forming a columnar member disposed between the substrate and the resin layer for forming a curved surface shape is formed; Step B in which the resin layer for forming a columnar member and the resin layer for forming a curved surface shape are etched to form a columnar laminate part comprising a columnar member and a member for forming a curved surface shape on the substrate; and Step C in which the member for forming a curved surface shape is heated to cause thermal sagging thereby forming a lens.

### TECHNICAL FIELD

The present invention relates to a method for producing a lens member, a lens member obtained by the said method, a method for producing a curved surface shape pattern, and a resin film for forming a curved surface shape pattern with which a lens or the like can be formed.

### BACKGROUND ART

In an IC technology and an LSI technology, in order to improve an operation speed as well as an integration degree, part of an electrical wiring on an electrical wiring board is replaced with an optical wiring such as an optical fiber and an optical waveguide so that an optical signal is used in place of an electrical signal.

For example, Patent Literature 1 discloses that an optical waveguide film is arranged above an IC chip provided with an optical element on surface thereof thereby carrying out optical communication between the IC chip and the optical waveguide film. However, when optical communication is made between a substrate, which is provided with an optical communication means such as an optical element, and an optical communication means such as an optical waveguide as shown in Patent Literature 1, there are problems that, unless these optical communication means are positioned with high accuracy to each other upon mounting them, the optical communication cannot be made, and that, unless a light is concentrated, a light loss (signal strength) decreases.

In order to solve these problems, a micro lens is being arranged on surface of the substrate.

For example, Patent Literature 2 discloses a substrate provided with a lens, that is, a micro lens arranged on surface of a transparent substrate is disclosed. To produce this substrate provided with the lens, a photosensitive resin resist is formed on surface of the transparent substrate, and also, a light shielding film having an opening portion on backside of the substrate is formed. Then, a light is irradiated from the side of the light shielding film to expose the photosensitive resin resist in a portion which exists at a location opposite to the opening portion of the light shielding film; and thereafter, development thereof is carried out to form a resist structure having a columnar shape. After that, this resist structure is heated to cause thermal sagging of surface of the resist structure, thereby producing the micro lens.

### CITATION LIST

### Patent Literature

Patent Literature 1: Japanese Patent Laid-Open Publication No. 2006-11210
Patent Literature 2: Japanese Patent Laid-Open Publication No. 2004-361858

### SUMMARY OF INVENTION

### Technical Problems

As in the case of Patent Literature 2, when a lens is formed on a substrate surface, because of small irregularity of substrate surface and difference in surface tension between a substrate surface and a material for forming a lens member, there have been problems that lens members having different shapes are formed and that a lens member cannot be formed in a narrow pitch. These are problematic not only in the case of a lens using a thermal sagging but also in the case that a lens member is formed by dropping a droplet resin onto a substrate; and further, these are problematic likewise in the case that a lens member is formed on a substrate itself by anisotropic etching after making a resist having a lens shape. As other example of the lens member, a micro lens having a convex lens projected from a pedestal by injection molding has been known; however, in this case, the lens member becomes thicker by the thickness of the pedestal, thereby leading to a problem that thickness of the composite of the substrate and the lens member becomes larger.

The present invention was made in view of the problems mentioned above, and has an object to provide: a method for producing a lens member with which an intended lens shape can be formed on an arbitrary substrate; a lens member obtained by the said method; a method for producing a curved surface shape pattern, and a resin film for forming a curved surface shape pattern with which a lens can be formed.

### Solution to Problems

Inventors of the present invention carried out an extensive investigation, and as a result of it, it was found that the problems mentioned could be solved by a production method of a lens member, wherein the method comprises: Step A in which a laminate body comprising a substrate, a resin layer for forming a curved surface shape disposed on the substrate, and a resin layer for forming a columnar member disposed between the substrate and the resin layer for forming a curved surface shape is formed; Step B in which the resin layer for forming a columnar member and the resin layer for forming a curved surface shape are etched to form a columnar laminate part comprising a columnar member and a member for forming a curved surface shape is formed on the substrate; and Step C in which the member for forming a curved surface shape is heated to cause thermal sagging thereby forming a lens. On the basis of this finding, the present invention could be achieved.

That is, the present invention provides the following (1) to (11).
(1) A method for producing a lens member, wherein the said method comprises:

Step A in which a laminate body comprising a substrate, a resin layer for forming a curved surface shape disposed on the substrate, and a resin layer for forming a columnar member disposed between the substrate and the resin layer for forming a curved surface shape is formed;

Step B in which the resin layer for forming a columnar member and the resin layer for forming a curved surface shape are etched to form a columnar laminate part comprising a columnar member and a member for forming a curved surface shape on the substrate; and

Step C in which the member for forming a curved surface shape is heated to cause thermal sagging thereby forming a lens.
(2) The method for producing a lens member according to (1), wherein the resin layer for forming a curved surface shape is a photosensitive resin layer.
(3) The method for producing a lens member according to (1) or (2), wherein the resin layer for forming a columnar member is a photosensitive resin layer.
(4) The method for producing a lens member according to any one of (1) to (3), wherein in the Step B, after the resin layer for forming a curved surface shape is photo-cured by light-exposure, the resin layer for forming a columnar member and the resin layer for forming a curved surface shape are etched.
(5) The method for producing a lens member according to any one of (1) to (4), wherein in the Step B, light-exposure of the resin layer for forming a curved surface shape and light-exposure of the resin layer for forming a columnar member are carried out at the same time to photo-cure the resin layer for forming a columnar member.
(6) The method for producing a lens member according to any one of (1) to (5), wherein the resin layer for forming a curved surface shape and/or the resin layer for forming a columnar member are resin layers formed of dry films.
(7) The method for producing a lens member according to any one of (1) to (6), wherein the substrate is a transparent substrate.
(8) A lens member obtained by the production method according to any one of (1) to (7).
(9) A method for producing a curved surface shape pattern, wherein the said method comprises the Step A and the Step B in the production method of a lens member according to any one of (1) to (7), and by thermal sagging of the member for forming a curved surface shape that is formed in the Step B, a curved surface shape is formed to the member for forming a curved surface shape.
(10) A resin film for forming a curved surface shape pattern, wherein the said resin film comprises a laminate body comprising a resin layer for forming a curved surface shape and a resin layer for forming a columnar member.
(11) The resin film for forming a curved surface shape pattern according to
(10), wherein the said resin film has a supporting film laminated on a side of the resin layer for forming a curved surface shape and/or a protective film laminated on a side of the resin layer for forming a columnar member.

### Advantageous Effects of Invention

According to the method for producing a lens member of the present invention, an intended lens shape can be formed on an arbitrary substrate. In addition, the curved surface shapes of the lens member and of the curved surface pattern obtained by the said method have an excellent intended shape. Moreover, according to the present invention, a resin film for forming a curved surface shape pattern capable of forming a lens having an intended shape can be obtained.

### BRIEF DESCRIPTION OF DRAWINGS

FIG. 1 is oblique views showing one embodiment of the production method of the lens member according to the present invention.

FIG. 2 is cross section views showing one embodiment of the production method of the lens member according to the present invention.

### DESCRIPTION OF EMBODIMENTS

### Lens Member:

The lens member in one embodiment of the present invention has the columnar member 3, which is projected on the substrate 1 from surface of the substrate 1, and is provided with a lens 6a having a curved convex surface on this columnar member 3.

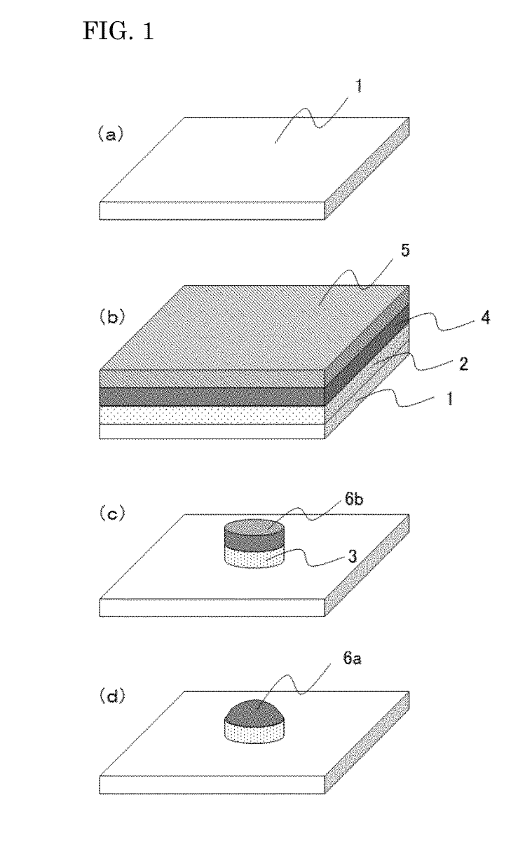

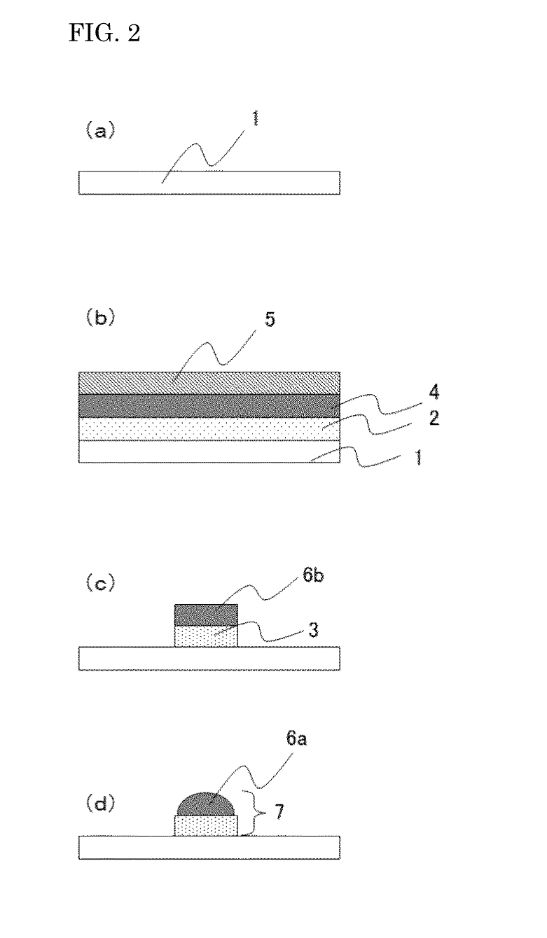

According to the method for producing a lens member in one embodiment of the present invention, the columnar member 3 is arranged between the substrate 1 and the lens 6a; and therefore, the lens 6a is not arranged directly on the substrate 1. In this way, even if surface of the substrate 1 has a surface condition such as small irregularity or there is a difference in surface tension between surface of the substrate 1 and a material for forming the lens, these effects do not affect formation of the lens 6a. As a result of it, a lens having a regular shape and a regular thickness can be formed. In addition, because the lens 6a is formed on the columnar member 3, misalignment of the lens central position can be suppressed. Moreover, by arbitrarily adjusting the height of the columnar member 3, the height of the lens from the surface of the substrate 1 can be arbitrarily adjusted with maintaining the lens shape (embodiment of FIG. 1 and FIG. 2).

The lens member configured in the way as mentioned above is used in an optical communication, for example, by arranging optical members such as a light emitting element, a light receiving element, and an optical waveguide in the position opposite to the lens 6a and the position opposite to the substrate 1, respectively.

For example, an optical signal emitted from the light emitting element which is present in the position opposite to the substrate 1 is concentrated by surface of the convex lens after passing through the columnar member 3 and the lens 6a, and then irradiated to the light receiving element which is present in the position opposite to the lens 6a. In this way, an optical communication can be made with a small light loss.

### Curved Surface Shape Pattern:

The curved surface shape pattern 7 in one embodiment of the present invention means the pattern having a curved surface formed on the substrate 1, and it comprises the columnar member 3 and the member (corresponding to the lens 6a) having a curved surface shape formed on the columnar member 3. The lens of the lens member as well as the columnar member in one embodiment of the present invention is also one kind (part) of the curved surface shape pattern.

As other example of the lens and the columnar member in the curved surface shape pattern in one embodiment of the present invention, there is an optical waveguide. If an optical waveguide comprising a clad layer having a low refractive index (corresponding to the columnar member 3) and a core layer having a high refractive index (corresponding to the lens 6a) is formed on a straight line, the cross section shape of the optical axis of the optical waveguide becomes a circle-like shape. And consequently, for example, an optical fiber having a circular cross section, and an optical waveguide having a low bonding loss with a photo diode and with a laser diode, which have a circular light receiving part, can be obtained. As other example of the optical waveguide, there is an optical waveguide which comprises a clad layer (corresponding to the columnar member 3) and a core layer (corresponding to the lens 6a) and is formed on the clad layer, wherein the refractive index thereof is higher than that of the clad layer. In this example, too, the same effect can be obtained.

As other example of the curved surface shape pattern 7, there is a plating resist. An electric wiring is formed, for example, in the way that an electric conductive layer is formed on the substrate 1, the curved surface shape pattern 7 is formed as a plating resist, an electric plating is carried out, and after an electric wiring is formed, the substrate and the electric conductive layer are removed, and further, the plating resist is removed. In this case, by using the curved surface shape pattern 7 as the plating resist, the plating resist can be removed more readily as compared with the plating resist having a rectangular cross section.

### Resin Film for Forming a Curved Surface Shape Pattern:

By using the resin film for forming a curved surface shape pattern, comprising a laminate body, comprising a curved surface shape forming resin layer 4 and a columnar member forming resin layer 2 in one embodiment of the present invention, the lens member in one embodiment of the present invention and the curved surface shape pattern in one embodiment of the present invention can be readily formed. The resin film for forming a curved surface shape pattern in one embodiment of the present invention may comprise a curved surface shape forming resin layer 4 which undergoes thermal sagging by heat and a columnar member forming resin layer 2 which does not undergo thermal sagging by heat. Alternatively, the resin film for forming a curved surface shape pattern in one embodiment of the present invention may comprise a laminate body produced by turning by light or heat one surface of a curved surface shape forming resin layer 4 which can undergo thermal sagging by heat, into the one surface which cannot undergo thermal sagging by heat, to form a columnar member forming resin layer 2. The resin film for forming a curved surface shape pattern is produced preferably by applying a resin of one resin layer onto the other resin layer or by adhering one resin layer with other resin layer. In this way the thickness of the resin film for forming a curved surface shape pattern can be controlled readily.

It is preferable to arrange the supporting film 5 by laminating thereof on the side of the curved surface shape forming resin layer 4 of the above-mentioned laminate body. In this way, not only handling of the laminate body can be made easily but also, even if light-exposure is made through the supporting film 5 by closely contacting with a photomask, the said light-exposure can be made without fouling the photomask. In view of the above-mentioned, it is preferable that the supporting film 5 be transparent to light-exposure in the degree not to adversely affect patterning by the light-exposure. In addition, it is preferable to arrange a protective film by laminating thereof on the side of the columnar member forming resin layer 2 of the above-mentioned laminate body. In this way, fouling of the resin surface can be suppressed. In addition, in the supporting film 5 and the protective film, it is preferable to use films having different thicknesses and materials to each other. In this way, the directions of the side of the curved surface shape forming resin layer 4 and of the side of the columnar member forming resin layer 2 in the resin film for forming a curved surface shape pattern can be readily distinguished. Further, it is preferable that the exfoliating force to exfoliate the supporting film 5 from the curved surface shape forming resin layer 4 be larger than the exfoliating force to exfoliate the protective film from the columnar member forming resin layer 2. With this, because the protective film can be readily exfoliated, the adhesion side of the columnar member forming resin layer 2 can be made bare, so that the chance to make a mistake in the adhesion direction can be reduced. Strength of the exfoliating force can be judged by observing on which film, the supporting film 5 or the protective film, the laminate body remains when these films are pulled at the same time; and it is preferable that the laminate body remain on the side of the supporting film 5.

Meanwhile, in one embodiment of the present invention, the member for forming a curved surface shape means the resin layer for forming a curved surface shape between after etching and before thermal sagging; and the lens means the part having functions to suppress the light spreading by changing the light angle, and to collimate or concentrate the light. The lens member means the entire member having the lens functions (lens provided with the substrate 1).

Next, the method for producing the lens member and the curved surface shape pattern will be explained.

### Step A:

In Step A in the production method for the lens member according to one different embodiment of the present invention, a laminate body comprising the substrate 1, the curved surface shape forming resin layer 4 disposed on the substrate 1, and the columnar member forming resin layer 2 disposed between the substrate 1 and the curved surface shape forming resin layer 4 is formed. As to the method for forming the laminate body, there is no particular restriction in it; and therefore, illustrative example of the method for forming the laminate body includes: the method in which the columnar member forming resin layer 2 in the form of a varnish and the curved surface shape forming resin layer 4 in the form of a varnish are successively applied onto the substrate 1 by using a comma coater, a die coater, a spin coater, or the like; the method in which the columnar member forming resin layer 2 in the form of a film (dry film) and the curved surface shape forming resin layer 4 in the form of a film (dry film) are successively laminated onto the substrate 1 by using a roll laminator, a vacuum roll laminator, a vacuum laminator, a normal pressure press, a vacuum press, or the like; the method in which after the columnar member forming resin layer 2 in the form of a film (dry film) is laminated onto the substrate 1, the curved surface shape forming resin layer 4 in the form of a varnish is applied onto the columnar member forming resin layer 2 in the form of a film (dry film); the method in which after the columnar member forming resin layer 2 in the form of a varnish is applied onto the substrate 1 to form the columnar member forming resin layer 2, the curved surface shape forming resin layer 4 in the form of a film (dry film) is laminated onto the columnar member forming resin layer 2; and the method in which after the laminate body comprising the columnar member forming resin layer 2 and the curved surface shape forming resin layer 4 is previously formed, the lamination is carried out by the above-mentioned methods in such a way that the side of the columnar member forming resin layer 2 of the laminate body may be adhered with the substrate 1.

Among the methods mentioned above, the method in which the columnar member forming resin layer 2 in the form of a film and the curved surface shape forming resin layer 4 in the form of a film are laminated is preferable. This is because a drying process after application of the varnish is not necessary. A more preferable method is the method in which after the laminate body comprising the columnar member forming resin layer 2 and the curved surface shape forming resin layer 4 is previously formed, lamination is carried out in such a way that the side of the columnar member forming resin layer 2 of the laminate body may be adhered with the substrate 1. By so doing, the number of the lamination times onto the substrate 1 can be made less.

### Step B:

In Step B in the production method for the lens member according to one different embodiment of the present invention, the columnar member forming resin layer 2 and the curved surface shape forming resin layer 4 are etched, preferably simultaneously, to form a laminate body (columnar laminate part) comprising the columnar member 3 and the member for forming a curved surface shape (hereunder, when the reference sign is given, this member is described as the curved surface shape forming member 6b) is formed on the substrate 1.

Illustrative example of the etching method includes dry etching such as RIE (Reactive Ion Etching) and wet etching in which the resin is dissolved or removed by swelling by using a solvent or an alkaline solution. For example, before dry etching or wet etching, an etching resist pattern which cannot be etched or is difficult to be etched is formed on the columnar member forming resin layer 2 and the curved surface shape forming resin layer 4. Then, the portions of the columnar member forming resin layer 2 and the curved surface shape forming resin layer 4 in which the etching resist pattern does not exist is removed; and thereafter, the etching resist pattern is removed. In the case that the wet etching is carried out, a resin capable of being etched by a solution or an alkaline solution may be used in the columnar member forming resin layer 2 and the curved surface shape forming resin layer 4.

An alternative wet etching method is the method in which the portion to become the columnar laminate part of the columnar member forming resin layer 2 and the curved surface shape forming resin layer 4 is photo-cured by using an active beam, and then, the wet etching is carried out. In this case, if at least the curved surface shape forming resin layer 4 is a photosensitive resin layer, the curved surface shape forming member 6b plays a substitute role of the etching resist, so that the columnar laminate part comprising the columnar member 3 and the curved surface shape forming member 6b can be formed. This method is preferable, if it is used, because the process in which the etching resist pattern is formed on the curved surface shape forming resin layer 4 and the process in which the etching resist pattern is removed are not necessary. It is more preferable if the columnar member forming resin layer 2 is also a photosensitive resin layer. With this, because the contrast between the uncured part which is removed by etching and the photo-cured part which is made to the columnar member 3 becomes clear in the resin layer for forming a columnar member, scraping-off of the side surface of the columnar member 3 can be suppressed, so that the identical shape of the columnar laminate part comprising the columnar member 3 and the curved surface shape forming member 6b can be readily obtained. In this case, it is more preferable that the light-exposure of the columnar member forming resin layer 2 and the light-exposure of the curved surface shape forming resin layer 4 be carried out at the same time. In this way, the light-exposure process can be simplified, and also, the columnar laminate part can be formed without causing misalignment of the columnar member 3 and the curved surface shape forming member 6b.

### Step C:

In Step C in the production method for the lens member according to one embodiment of the present invention, the curved surface shape forming member 6b is heated to cause thermal sagging thereby forming a lens 6a or the curved surface shape pattern 7 (laminate pattern of the lens 6a and the columnar member 3). Because the curved surface shape forming member 6b is formed on the columnar member 3, even if the viscosity thereof becomes low by thermal sagging, it remains on the columnar member 3 due to the surface tension. Therefore, the lens 6a or the curved surface shape pattern 7 can be obtained in good condition regardless of the kind and the surface roughness of the substrate 1. As to the temperature for thermal sagging, there is no particular restriction in it, provided that with this temperature the viscosity of the curved surface shape forming member 6b can be lowered to form the curved surface; and therefore, the temperature thereof is preferably in the range of 40° C. to 270° C., while more preferably in the range of 80° C. to 230° C. In order to keep transparency of the lens 6a and the columnar member 3, the temperature is still more preferably in the range of 80° C. to 180° C. After thermal sagging, heating may be made to cure the lens 6a and the columnar member 3, wherein the temperature for heating may be the same or higher than the above mentioned temperature; however, in order to keep transparency of the lens 6a and the columnar member 3, the temperature is preferably in the range of 80° C. to 180° C.

Next, the member of the lens and the curved shape pattern each will be explained.

### Substrate:

As to the material of the substrate, there is no particular restriction in it and therefore, illustrative example thereof includes a glass epoxy resin substrate, a ceramic substrate, a glass substrate, a silicon substrate, a plastic substrate, a metal substrate, a substrate provided with a resin layer, a substrate provided with a metal layer, a resin film, and an electric wiring board. Illustrative example of the preferable resin film includes films of: polyesters such as polyethylene terephthalate, polybutylene terephthalate, and polyethylene naphthalate; polyolefins such as polyethylene and polypropylene; and polyamides, polycarbonates, polyphenylene ethers, polyether sulfides, polyarylates, liquid crystal polymers, polysulfones, polyether sulfones, polyether ether ketones, polyether imides, polyamide imides, and polyimides.

As to the thickness of the substrate, there is no particular restriction in it however, in order to secure the strength and to reduce the light loss by shortening of the light path, the thickness of the substrate is preferably in the range of 5 μm to 1 mm, while more preferably in the range of 10 μm to 100 μm.

In the case that an optical signal transmits the substrate 1, the substrate 1 through which a used optical signal can transmit may be used; and for example, in the case that a used optical signal is that of an infrared light, a resin substrate, a silicon substrate, and the like, through which an infrared light can transmit, may be used.

### Lens:

As to the material of the lens 6a, there is no particular restriction in it, provided that it is transparent to an optical signal; however, in view of production method as mentioned above, it is preferably a cured product of a photosensitive resin composition and/or a thermosetting resin composition.

As to this photosensitive resin composition, a composition comprising (a) a binder polymer, (b) a photo-polymerizable unsaturated compound having an ethylenic unsaturated group, and (c) a photo-polymerization initiator, is preferable.

The lens 6a is more preferable because it can be formed on the columnar member 3 in such a way that the lens center position is not eccentric when using either a resin composition capable of becoming a lens shape by curing thereof after it is liquefied or a resin composition in a liquid form. In the case that viscosity in the state of liquid is low, the lens center is automatically aligned with the center of the columnar member 3 on the columnar member 3. In view of the above-mentioned, convex lens shapes such as a spherical surface and a non-spherical surface is preferable.

In the case that the lens 6a is formed by a photo lithography process, thickness of the curved surface shape forming member 6b (thickness of the curved surface shape forming member 6b on the columnar member 3) may be arbitrarily selected in accordance with the lens shape after thermal sagging.

In the case of the curved surface shape pattern, too, the same resin composition as that of the above-mentioned may be used as well; however, in the case of the curved surface shape pattern not propagating a light, transparency in the resin is not necessary.

### Columnar Member:

As to the columnar member 3, a material which can be formed on the substrate 1 but does not undergo thermal sagging at the temperature to cause thermal sagging in the curved surface shape forming member 6b may be used. In the case that an optical signal transmits through the columnar member 3, the columnar member 3 which is transparent at the wavelength of the optical signal may be used. As to the material of the columnar member 3, there is no particular restriction in it; however, in view of the production method mentioned above, a photosensitive resin composition and a cured product thereof are preferable, while a negative type photosensitive resin composition and a cured product thereof are more preferable.

By arbitrarily selecting the height of the columnar member 3 from the surface of the substrate 1, the height of the lens 6a and the shape of the curved surface shape pattern 7 may be selected. The height from the surface of the substrate 1 is arbitrarily selected in accordance with the thickness of the curved surface shape forming member 6b to be formed on the columnar member 3 (this thickness may be the thickness of the lens 6a); however, in order to secure the distance between the lens 6a and the surface of the substrate 1, the thickness thereof is preferably 5 μm or more; and the thickness thereof is preferably 100 μm or less because the thickness can be readily controlled by this thickness. In view of control of the thickness of the resin layer for forming a curved surface shape, the thickness thereof is more preferably 50 μm or less.

### Application Example of the Lens:

The lens of the lens member in one embodiment of the present invention may be used as a micro lens array in which a plurality of lenses are disposed on the same substrate. As an alternative application example, the lens of the lens member in one embodiment of the present invention may be used as an optical waveguid provided with a mirror and a rens, in which the rens of the rens member in one embodiment of present invention and an optical path conversion mirror are disposed in the position at which an optical signal can be sent and received. The optical waveguid is an optical waveguid provided with an optical path conversion mirror of the optical waveguide, in which an waveguide comprising a lower clad layer, a core pattern and an upper clad layer, and an optical path conversion mirror of the optical waveguide positioned on the core pattern optical axis of the optical waveguide are provided. By having this lens, because the optical signal sent from an optical fiber and a light emitting element such as a laser diode can be concentrated or collimated so as to be propagated to the optical waveguide, a coupling loss can be improved. Alternatively, because spreading of an optical signal from the optical waveguide can be suppressed by the lens, a coupling loss with an optical fiber and a light receiving element such as a photo diode can be improved.

### EXAMPLES

Hereunder, the present invention will be explained in more detail by Examples; however, the present invention is not restricted by these Examples.

### Example 1

In the procedure as described below, the lens member shown in FIG. 1 and FIG. 2 was prepared and evaluated.

### Preparation of the Resin Layer for Forming the Columnar Member:

(A) Base Polymer: Preparation of (meth)acryl Polymer (A-1)

Into a flask equipped with a stirrer, a cooling tube, a gas introducing tube, a dropping funnel, and a thermometer were weighed 46 parts by mass of propylene glycol monomethyl ether acetate and 23 parts by mass of methyl lactate; and then, the resulting mixture was stirred with introducing a nitrogen gas. After the liquid temperature thereof was raised to 65° C., into this mixture was gradually added during a period of 3 hours a mixture of 47 parts by mass of methyl methacrylate, 33 parts by mass of butyl acrylate, 16 parts by mass of 2-hydroxyethyl methacrylate, 14 parts by mass of methacrylic acid, 3 parts by mass of 2,2′-azobis(2,4-dimethylvaleronitrile), 46 parts by mass of propylene glycol monomethyl ether acetate, and 23 parts by mass of methyl lactate; and then, this reaction mixture was stirred at 65° C. for 3 hours, and then, at 95° C. for 1 hour to obtain the solution of the (meth)acryl polymer (A-1) (solid component concentration of 45% by mass).

### Measurement of the Weight-Average Molecular Weight:

As a result of measurement by using a GPC (“SD-8022”, “DP-8020”, and “RI-8020”; all manufactured by Tosoh Corp.), the weight-average molecular weight (converted to standard polystyrene) of (A-1) was determined to be 3.9×10⁴. Meanwhile, the columns “Gelpack GL-A150-S” and “Gelpack GL-A160-S” (both manufactured by Hitachi Chemical Co., Ltd.) were used here (“Gelpack” is a registered trade name).

### Measurement of the Acid Value:

The acid value of A-1 was determined to be 79 mg-KOH/g as a result of the measurement thereof. Meanwhile, the acid value was calculated from the amount of the 0.1 mol/L potassium hydroxide aqueous solution necessary to neutralize the A-1 solution. In this measurement, the point at which the color of the colorless phenolphthalein added as an indicator changed to a pink color was taken as the neutral point thereof.

### Preparation of the Resin Varnish for Forming the Columnar Member:

As (A) the base polymer 84 parts by mass (solid component of 38 parts by mass) of the A-1 solution (solid component concentration of 45% by mass), as (B) the photo-curing component 33 parts by mass of urethane (meth)acrylate having a polyester skeleton (“U-200AX”; manufactured by Shin-Nakamura Chemical Co., Ltd.) and 15 parts by mass of urethane (meth)acrylate having a polypropylene glycol skeleton (“UA-4200”; manufactured by Shin-Nakamura Chemical Co., Ltd.), as (C) the thermosetting component 20 parts by mass (solid component of 15 parts by mass) of polyfunctional blocked isocyanate solution (solid component concentration of 75% by mass) whose isocyanurate type trimer of hexamethylene diisocyanate is protected by methyl ethyl ketone oxime (“Sumidur BL3175” (“Sumidur” is a registered trade name); manufactured by Sumika Bayer Urethane Co., Ltd.), as (D) the photo-polymerization initiator 1 part by mass of 1-[4-(2-hydroxyethoxy)phenyl]-2-hdyroxy-2-methyl-1-proane-1-one (“Irgacure 2959” (“Irgacure” is a registered trade name); manufactured by BASF SE) and 1 part by mass of bis(2,4,6-trimethylbenzoyl) phenyl phosphine oxide (“Irgacure 819”; manufactured by BASF SE), and as the diluent organic solvent 23 parts by mass of propylene glycol monomethyl ether acetate were mixed with stirring. Then, after this mixture was filtrated with applying a pressure by using a polyflon filter having the pore diameter of 2 μm (“PF020”; manufactured by Advantec Toyo Kaisha, Ltd.), the filtrate was defoamed under reduced pressure to obtain the resin varnish for forming the columnar member.

### Preparation of the Resin Film (Dry Film) for Forming the Columnar Member:

The resin varnish for forming the columnar member obtained as mentioned above was applied onto an untreated surface of the PET film (“Cosmoshine A4100” with the thickness of 50 μm (“Cosmoshine” is a registered trade name); manufactured by Toyobo Co., Ltd.), which is a supporting film (after laminated with the resin film for forming the curved surface shape which will be mentioned later, this is used as a protective film), by using a coating machine (“Multicoater TM-MC”; manufactured by Hirano Tecseed Co., Ltd.). After it was dried at 100° C. for 20 minutes, as a protective film, a surface release type treated PET film (“Purex A31” with the film thickness of 25 μm (“Purex” is a registered trade name); manufactured by Teijin DuPont films Japan Ltd.) was adhered with it to obtain the resin film for forming the columnar member.

The thickness of the columnar member forming resin layer (film) 2 can be arbitrarily adjusted by controlling a gap of the coating machine; and this is described in Example. The film thickness of the columnar member forming resin layer 2 described in Example is the film thickness after coating and drying.

### Preparation of the Resin Layer (Dry Film) for Forming the Curved Surface Shape:

Into a flask equipped with a stirrer, a reflux condenser, an inert gas introducing opening, and a thermometer was charged 190 parts by mass of propylene glycol monomethyl ether acetate, and then, the temperature thereof was raised to 80° C. under a nitrogen gas atmosphere. And then, with keeping the reaction temperature at 80° C., into this solution were gradually and evenly added, during a period of 4 hours, 10 parts by mass of methacrylic acid, 1 part by mass of n-butyl methacrylate, 74 parts by mass of benzyl methacrylate, 15 parts by mass of 2-hydroxyethyl methacrylate, and 2.5 parts by mass of 2,2′-azobis(isobutyronitrile). After completion of the gradual addition, stirring of the reaction mixture was continued at 80° C. for 6 hours to obtain a solution of the binder polymer (a) with the weight-average molecular weight of about 30,000 (solid component concentration of 35% by mass).

Next, into 200 parts by mass (solid component of 70 parts by mass) of the solution of the binder polymer (a) (solid component concentration of 35% by mass) were added 8 parts by mass of 2,2-bis(4-(di(meth)acryloxypolyethoxy)phenyl)propane, 22 parts by mass of p-hydroxyethyl-(3′-(meth)acryloyloxyethyl-o-phthalate, 2.1 parts by mass of 2-(o-chlorophenyl)-4,5-diphenyl imidazole dimer, 0.33 parts by mass of N,N′-tetraethyl-4,4′-diaminobenzophenone, 0.25 parts by mass of mercaptobenzoimidazole, 8 parts by mass of (3-methacryloylpropyl)trimethoxy silane, and 30 parts by mass of methyl ethyl ketone; and then, they were mixed by using a stirrer for 15 minutes to obtain a solution of the resin composition for forming the curved surface shape.

As the supporting film 5, a polyethylene terephthalate film having a thickness of 16 μm was used, and the solution of the resin composition for forming the lens member obtained as mentioned above was applied uniformly onto the supporting film by using a comma coater; and then, the solvent contained therein was removed by drying for 3 minutes by using a hot air convection type dryer at 100° C. to form the curved surface shape forming resin layer 4. In this Example, the thickness of the curved surface shape forming resin layer (film) 4 used therein is described in Example. The film thickness of the curved surface shape forming resin film 4 described in Example is the film thickness after coating and drying.

Next, as a protective film, a polyethylene phthalate film having the thickness of 25 μm was further adhered onto the curved surface shape forming resin layer 4 to obtain the curved surface shape forming resin layer 4.

### Preparation of the Laminate Body Comprising the Resin Layer for Forming the Curved Surface Shape and the Resin Layer for Forming the Columnar Member:

Each protective film of the curved surface shape forming resin layer 4 having the thickness of 30 μm and the columnar member forming resin layer 2 having thickness of 25 μm was exfoliated, and then, both the resin surfaces were laminated by using the roll laminator (“HLM-1500”: manufactured by Hitachi Chemical Techno-Plant Co., Ltd.) with the conditions of the pressure of 0.4 MPa, the temperature of 40° C., and the laminating rate of 0.2 m/minute to obtain the laminate body comprising the resin layer for forming the curved surface shape and the resin layer for forming the columnar member. When each of the supporting films was peeled off, the laminate body was left on the supporting film 5 on the side of the curved surface shape forming resin layer 4. The supporting film on the side of the columnar member forming resin layer 2 was regarded as the protective film of the laminate body comprising the curved surface shape forming resin layer 4 and the columnar member forming resin layer 2.

### Step A:

The protective film of the laminate body obtained as mentioned above, the said laminate body being comprised of the curved surface shape forming resin layer 4 and the columnar member forming resin layer 2, was exfoliated, and then, the laminate body was disposed on a polyimide film having the size of 150 mm×150 mm (polyimide “Upilex RN” with the thickness of 25 μm (“Upilex” is a registered trade name); manufactured by Ube-Nitto Kasei Co., Ltd.). Thereafter, by using a vacuum pressing type laminator (“MVLP-500” (“MVLP” is a trade name); manufactured by Meiki Co., Ltd.), the system was evacuated to 500 Pa or less, and then lamination was carried out with a thermal press adhesion method under the conditions of the pressure of 0.4 MPa, the temperature of 80° C., and the pressing time of 30 seconds (see, FIG. 1(b) and FIG. 2(b)).

### Step B:

Next, via a negative photomask having a circular opening part with a diameter of 210 μm, an UV beam (wavelength of 365 nm) was irradiated with the irradiation amount of 0.3 J/cm² from the side of the supporting film 5 by using the UV beam irradiating machine (name of the machine was “EXM-1172”; manufactured by ORK Manufacturing Co., Ltd.). Thereafter, the supporting film 5 was exfoliated, and then, etching was carried out by using the developing solution of an aqueous solution containing 1.0% by mass of potassium carbonate; and then, drying was carried out at 170° C. for 1 hour to obtain the laminate body comprising the columnar member 3 and the curved surface shape forming member 6b (see, FIG. 1(c) and FIG. 2(c)).

### Step C:

Thereafter, the curved surface shape forming member 6b was heated at 180° C. for 1 hour to cause thermal sagging thereby forming a lens 6a on the columnar member 3 (see, FIG. 1(d) and FIG. 2(d)).

### Evaluation:

As a result of observation of the lens 6a, the diameter thereof was 210 μm, the height of the cross section shape was 30 μm, and the curvature radius was 200 μm. The cross section shape on the side of the columnar member 3 showed that the height from the substrate flat surface was 25 μm and that it was flat. By using an optical fiber for the GI 50 multimode as an entering part, an optical signal of 850 nm was entered from the side of the columnar member 3; and when the distance between the optical fiber edges of the optical fiber for the multimode GI 62.5, which was arranged as a light receiving part on the side of the lens 6a, was made to 100 μm, the optical propagation loss was 0.45 dB. When the distance between the optical fiber edges was made to 200 μm, the optical propagation loss was 0.53 dB; and therefore, the optical signal could be transmitted satisfactorily.

### Example 2

On a polyimide film having the size of 150 mm×150 mm (polyimide “Upilex RN” with the thickness of 25 μm; manufactured by Ube-Nitto Kasei Co., Ltd.), the protective film of the columnar member forming resin layer 2 having the thickness of 25 μm, which was obtained as mentioned above, was exfoliated, and the columnar member forming resin layer 2 was evacuated to 500 Pa or less by using a vacuum pressing type laminator (“MVLP-500”; manufactured by Meiki Co., Ltd.), and then, it was laminated with a thermal press adhesion method under the conditions of the pressure of 0.4 MPa, the temperature of 80° C., and the pressing time of 30 seconds. Next, the protective film of the curved surface shape forming resin layer 4 having the thickness of 30 μm was exfoliated; and then, on the columnar member forming resin layer 2 after exfoliating the protective film, after the system was evacuated to 500 Pa or less by using a vacuum pressing type laminator mentioned above, the curved surface shape forming resin layer 4 was laminated with a thermal press adhesion method under the conditions of the pressure of 0.4 MPa, the temperature of 80° C., and the pressing time of 30 seconds.

As to the processes after the light-exposure, the same procedure as that of Example 1 was repeated to form the lens 6a on the columnar member 3.

### Evaluation:

As a result of observation of the lens 6a, the diameter thereof was 210 μm, the height of the cross section shape was 30 μm, and the curvature radius was 200 μm. The cross section shape on the side of the columnar member 3 showed that the height from the substrate flat surface was 25 μm and that it was flat. By using an optical fiber for the GI 50 multimode as an entering part from the side of the columnar member 3, an optical signal of 850 nm was entered; and when the distance between the optical fiber edges of the optical fiber for the multimode GI 62.5, which was arranged as a light receiving part on the side of the lens 6a, was made to 100 μm, the optical propagation loss was 0.46 dB. When the distance between the optical fiber edges was made to 200 μm, the optical propagation loss was 0.51 dB; and therefore, the optical signal could be transmitted satisfactorily.

### Comparative Example 1

The same procedure as that of Example 3 was repeated, except that the columnar member 3 was not formed and that the thickness of the curved surface shape forming resin layer 4 was changed to 25 μm, to obtain the substrate provided with the lens.

### Evaluation:

As a result of observation of the lens 6a, the diameter thereof was 250 μm, the height of the cross section shape was 20 μm, and there was variation in the curvature radius.

### REFERENCE SIGNS LIST

1 Substrate
2 Resin layer for forming a columnar member (columnar member forming resin layer)
3 Columnar member
4 Resin layer for forming a curved surface shape (curved surface shape forming resin layer)
5 Supporting film
6a Lens
6b Member for forming a curved surface shape (curved surface shape forming member)
7 Curved surface shape pattern

1. A method for producing a lens member, wherein the said method comprises:
Step A in which a laminate body comprising a substrate, a resin layer for forming a curved surface shape disposed on the substrate, and a resin layer for forming a columnar member disposed between the substrate and the resin layer for forming a curved surface shape is formed;
Step B in which the resin layer for forming a columnar member and the resin layer for forming a curved surface shape are etched to form a columnar laminate part comprising a columnar member and a member for forming a curved surface shape on the substrate; and
Step C in which the member for forming a curved surface shape is heated to cause thermal sagging thereby forming a lens.

2. The method for producing a lens member according to claim 1, wherein the resin layer for forming a curved surface shape is a photosensitive resin layer.

3. The method for producing a lens member according to claim 1, wherein the resin layer for forming a columnar member is a photosensitive resin layer.

4. The method for producing a lens member according to claim 1, wherein in the Step B, after the resin layer for forming a curved surface shape is photo-cured by light-exposure, the resin layer for forming a columnar member and the resin layer for forming a curved surface shape are etched.

5. The method for producing a lens member according to claim 1, wherein in the Step B, light-exposure of the resin layer for forming a curved surface shape and light-exposure of the resin layer for forming a columnar member are carried out at the same time to photo-cure the resin layer for forming a columnar member.

6. The method for producing a lens member according to claim 1, wherein the resin layer for forming a curved surface shape and/or the resin layer for forming a columnar member are resin layers formed of dry films.

7. The method for producing a lens member according to claim 1, wherein the substrate is a transparent substrate.

8. A lens member obtained by the production method according to claim 1.

9. A method for producing a curved surface shape pattern, wherein the said method comprises the Step A and the Step B in the production method of a lens member according to claim 1, and by thermal sagging of the member for forming a curved surface shape that is formed in the Step B, a curved surface shape is formed to the member for forming a curved surface shape.

10. A resin film for forming a curved surface shape pattern, wherein the said resin film comprises a laminate body comprising a resin layer for forming a curved surface shape and a resin layer for forming a columnar member.

11. The resin film for forming a curved surface shape pattern according to claim 10, wherein the said film has a supporting film laminated on a side of the resin layer for forming a curved surface shape and/or a protective film laminated on a side of the resin layer for forming a columnar member.
